(19) United States
(12) Patent Application Publication
(10) Pub. No.: US 2026/0110783 A1
(43) Pub. Date: Apr. 23, 2026

(54) METHOD AND SYSTEM FOR DETECTING OBJECTS IN A FIELD OF VIEW OF A LIDAR DEVICE

(71) Applicant: Robert Bosch GmbH, Stuttgart (DE)

(72) Inventors: Mario Lietz, Vaihingen An Der Enz (DE); Benjamin Schmidt, Stuttgart (DE)

(21) Appl. No.: 19/351,554

(22) Filed: Oct. 7, 2025

(30) Foreign Application Priority Data
Oct. 21, 2024 (DE) 10 2024 210 152.4

(51) Int. Cl. G01S 7/487; G01S 7/481; G01S 17/42

(52) U.S. Cl. CPC G01S 7/4876; G01S 7/4816; G01S 7/4817; G01S 17/42

(57) ABSTRACT

A method for detecting objects in a field of view of a lidar device. A plurality of light pulses are emitted into adjacent solid angles; received secondary light of an object from these adjacent solid angles is measured and converted into individual digital signals of the respective adjacent solid angles; the signals from adjacent solid angles are aggregated without reducing the angular resolution; during the aggregation at least partially coinciding signal structures are recognized using a coincidence filter, with respect to their amplitude, in the individual signals of different solid angles for a specific object; the signals are aggregated by a threshold filter; the received and/or aggregated signals are compared with an adaptable threshold value, so that secondary light of the object received in the signals is differentiated from interfering signals, and the interfering signals are filtered out.

### CROSS REFERENCE

The present application claims the benefit under 35 U.S.C. § 119 of Germany Patent Application No. DE 102024 210 152.4 filed on October 21, 2024, which is expressly incorporated herein by reference in its entirety.

### BACKGROUND INFORMATION

Conventional methods for detecting objects in a field of view using a lidar system are usually based on emitting light pulses and measuring the reflected secondary light to determine the position and distance of objects. However, some of these methods have limitations, particularly in dealing with interfering signals and the accuracy of object detection.

A typical lidar system emits light pulses at multiple solid angles and captures the reflected light with a receiving unit. The received light is then converted into signals and evaluated by a processor unit to ascertain distance and position data.

The conventional methods are often limited by their rigid filter mechanisms, limited resolution capability and lack of adaptability to varying environmental conditions. These problems can lead to reduced accuracy and reliability of object detection, in particular in challenging or dynamic environments.

An object of the present invention is to provide a method for detecting objects in a field of view of a lidar device, which method enables more precise and more reliable object detection.

### SUMMARY

The present invention relates to a method for detecting objects in a field of view of a lidar (light detection and ranging) device, wherein the lidar device comprises a transmitting unit, a receiving unit and a processor unit. According to an example embodiment of the present invention, a plurality of light pulses are emitted into adjacent solid angles and the received secondary light of an object from these adjacent solid angles is measured by means of at least one detector of the receiving unit and converted into individual digital signals of the respective adjacent solid angles. The signals from adjacent solid angles are aggregated without reducing the angular resolution. During the aggregation, at least partially coinciding signal structures in the signals of different solid angles are recognized using a first filter, in particular with respect to their amplitude, in order to identify a specific object. In addition, the signals are aggregated by a threshold filter, wherein the processor unit compares the received and/or aggregated signals with an adaptable threshold value, so that received secondary light of the object is differentiated from interfering signals, such as background noise and/or stray light, and the interfering signals are consequently filtered out.

According to an example embodiment of the present invention, the lidar device is a technical device for the optical capturing of objects, which emits light pulses and measures the reflected secondary light. The transmitting unit is used to emit the light pulses into different solid angles. The receiving unit comprises at least one detector which receives the secondary light, and this secondary light is converted into digital signals. The processor unit evaluates these signals by aggregating and filtering them. The coincidence filter recognizes signal structures that coincide in the signals of the adjacent solid angles, while the threshold filter separates the received secondary light from interfering signals.

An advantage of the method of the present invention is that the aggregation of the signals improves the signal-to-noise ratio without compromising the angular resolution. This leads to more precise object detection because interfering signals are effectively filtered out. The combination of coincidence and threshold filters enables increased sensitivity of the lidar device and improved differentiation of relevant signals and background noise.

Advantageously, according to an example embodiment of the present invention, a deflection unit with rotating mirrors can be used to scan solid angles in a horizontal direction and/or a vertical direction.

According to an example embodiment of the present invention, the deflection unit is a mechanical and optical device that directs the light pulses in different solid angles to expand the field of view of the lidar device. Rotating mirrors ensure that the light pulses are emitted into the desired solid angles.

This achieves complete coverage of the field of view of the lidar device, which improves the recognition of objects in different positions and solid angles.

Advantageously, according to an example of the present invention, the receiving unit can comprise detectors which are interconnected to form a macro-pixel, it being possible for at least 4, preferably 16, sub-pixels to be interconnected to form a macro-pixel.

The signals of sub-pixels are aggregated to form a common signal of the macro-pixel in order to improve the signal-to-noise ratio.

A macro-pixel is a group of sub-pixels, the signals of which are combined to generate a stronger and less noisy signal. This structure enables a higher sensitivity of the lidar device.

Advantageously, according to an example embodiment of the present invention, the light pulses are emitted either as individual light pulses per solid angle or as multiple light pulses per solid angle, preferably at least 3 light pulses per solid angle.

A light pulse is a short emission of light emitted by the transmitting unit. Individual light pulses consist of an individual light signal, whereas multiple light pulses transmit a plurality of signals into the same solid angle to improve data capturing.

The multiple light pulses can be emitted successively into the same solid angle.

This increases the probability of detecting reflected secondary light, in particular for weakly reflective objects, which improves the recognition rate.

Advantageously, according to an example embodiment of the present invention, the processor unit can evaluate the aggregated signals to detect objects in adjacent solid angles.

The processor unit processes the aggregated signals from the adjacent solid angles to determine the position and distance of the objects in the field of view. An object is captured as reflected secondary light in the signals of the adjacent angles.

This increases the precision of the object detection since the signals are comprehensively analyzed from different angles.

Advantageously, according to an example embodiment of the present invention, the signals are aggregated in a continuous scan cycle, whereby measurements of the received secondary light are continuously performed in the adjacent solid angles.

A scan cycle is the period of time during which the field of view of the lidar device is continuously scanned in order to continuously collect and process data.

This enables real-time monitoring of the field of view, which improves the responsiveness of the lidar device.

Advantageously, according to an example embodiment of the present invention, the signals are aggregated in a plurality of solid angles by adaptive filtering which is matched to the properties of the received signals, wherein the individual threshold values of the threshold filter are adapted to an amplitude of the background noise and/or the threshold values of the threshold filter are adapted to a distance of the captured object and/or the threshold values of the threshold filter are adapted to an amplitude of a stray light, in particular in the case of objects recorded in close proximity.

Adaptive filtering is a process in which the filter dynamically adapts its parameters to the current characteristics of the received signal in order to maximize the efficiency of the signal processing. The threshold filter differentiates reflected secondary light of an object from background noise and stray light and adapts its threshold values according to the signal conditions.

This improves signal separation in different environments because the filter can respond flexibly to changes in background noise, the distance of the object and the intensity of the stray light.

Advantageously, according to an example embodiment of the present invention, the processor unit can perform a real-time correction of the signals in order to improve the accuracy of the object detection; the real-time correction checks the recorded signals for errors caused, for example, by a fault in a detector of the receiving unit and/or a fault in a laser of the transmitting unit.

Real-time correction is a process in which the processor unit checks the received signals for errors in real time and automatically corrects them. Such errors can be caused by various faults, such as malfunctions of a detector in the receiving unit or by faults in a laser in the transmitting unit. Real-time correction allows these errors to be identified and corrected immediately without interrupting ongoing signal processing.

This significantly improves the accuracy of the object detection because signal errors caused by faults in the transmitting or receiving unit are corrected in real time.

Advantageously, according to an example embodiment of the present invention, the deflection unit can be configured to deflect the emitted light pulses in a predetermined pattern, preferably a serpentine or spiral pattern, to enable comprehensive scanning of the field of view.

The deflection unit deflects the light pulses in a specific pattern to ensure systematic scanning of the entire field of view of the lidar device. The patterns, for example the serpentine or spiral pattern, allow for even coverage of the field of view.

This ensures complete coverage of the field of view.

Advantageously, according to an example embodiment of the present invention, the processor unit can comprise a learning algorithm based on machine learning, wherein the learning algorithm is trained with training data from older measurements for the detection of objects and recognized objects are compared with actually present objects, wherein the measurements with correctly recognized objects are given a higher weighting, so that the accuracy of the object detection is increased.

A learning algorithm (artificial intelligence algorithm) is a machine learning system that is optimized by means of training data. The algorithm compares recognized objects with actual objects and uses successfully recognized objects to improve its accuracy.

This continuously improves the detection accuracy since the algorithm learns from the training data and increases its recognition rate.

Advantageously, according to an example embodiment of the present invention, the receiving unit can be configured to process signals from a plurality of detectors simultaneously.

Simultaneous processing means that the receiving unit captures and evaluates a plurality of signals simultaneously without delaying the processing of the individual signals.

This increases the efficiency of the signal processing, leading to faster and more precise object detection.

Advantageously, according to an example embodiment of the present invention, the signals are alternatively aggregated by sequential processing of the successively received light pulses, wherein a temporal correlation between the individual signals is used to recognize objects.

Sequential processing is the process by which the received light pulses are processed in the order in which they arrive, using temporal relationships between the signals to detect objects.

This improves the ability of the system to precisely recognize movements and changes in the field of view.

Advantageously, according to an example embodiment of the present invention, the signals are aggregated in adjacent solid angles in a range between 0.01° and 0.1° by, in a first step, converting the measured signals from a plurality of solid angles into histograms, wherein, in a second step, signal structures are recognized for each individual solid angle by applying a first threshold filter with an adaptable threshold value, wherein, in a third step, the recognized signal structures for the individual solid angles are compared by means of the coincidence filter and/or a second threshold filter with a second adaptable threshold value is applied, so that secondary light of the object received in the signals is differentiated from interfering signals, such as background noise and/or stray light, and the interfering signals are consequently filtered out.

A histogram is a graphical representation of the distribution of signal values, which in this case is used to process the signals from different solid angles. The threshold filter recognizes signal structures, while the coincidence filter checks the coincidence of these structures.

This increases the precision of the object detection because interfering signals are effectively filtered out and relevant signal structures are correctly identified.

Advantageously, according to an example embodiment of the present invention, the signals are aggregated in adjacent solid angles in a range between 0.01° and 0.1° by, in a first step, converting the measured signals from a plurality of solid angles into histograms, wherein, in a second step, the individual histograms of at least two adjacent solid angles are aggregated and at least one aggregated histogram is generated, wherein, in a third step, signal structures are recognized in the aggregated histogram by applying a first threshold filter with an adaptable threshold value, wherein, in a fourth step, the recognized signal structures for the individual solid angles are compared by means of the coincidence filter and/or a second threshold filter with a second adaptable threshold value is applied, so that secondary light of the object received in the signals is differentiated from interfering signals, such as background noise and/or stray light, and is consequently filtered out.

An aggregated histogram is a merging of the signal distributions from a plurality of solid angles, which are processed by threshold and coincidence filters to extract relevant signals and interfering signals.

This optimizes the signal processing because the aggregation of histograms increases the detection efficiency and improves the accuracy of the object detection.

The present invention further relates to a system for detecting objects in a field of view of a lidar device. According to an example embodiment of the present invention, the system comprises a transmitting unit, a receiving unit, a deflection unit and a processor unit. The transmitting unit emits a plurality of light pulses into adjacent solid angles, and the receiving unit measures the received secondary light from these solid angles and converts it into digital signals. The signals from adjacent solid angles are aggregated without reducing the angular resolution, and the signals are cleaned by a threshold filter. The processor unit compares the received and/or aggregated signals with an adaptable threshold value in order to differentiate echo signals of an object from background noise and to filter out the background noise.

This system enables precise and efficient object detection according to the method described above by aggregating the signals of the adjacent solid angles and eliminating interfering signals by means of the threshold filter, which increases the accuracy and reliability of the lidar device.

### BRIEF DESCRIPTION OF THE DRAWINGS

The present invention is explained with reference to the figures.

FIG. 1 is a schematic representation for illustrating a method for detecting objects in a field of view of a lidar device.

FIG. 2 is a schematic representation of histograms and echo diagrams of the method according to FIG. 1.

FIG. 3 is a schematic representation for illustrating an alternative method in comparison with FIG. 1.

### DETAILED DESCRIPTION OF EXAMPLE EMBODIMENTS

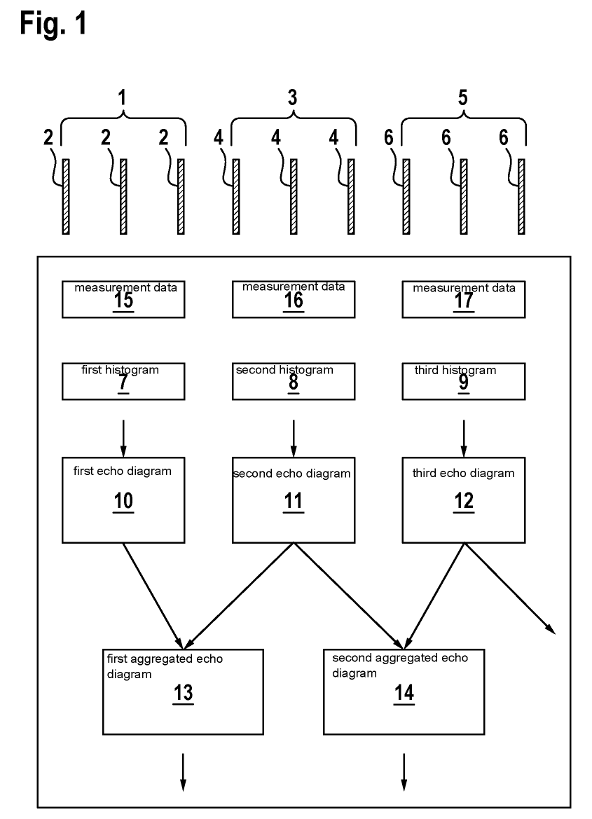

FIG. 1 is a schematic representation for illustrating a method for detecting objects in a field of view of a lidar device, wherein the lidar device comprises a transmitting unit comprising a laser, a receiving unit comprising a detector, and a processor unit. Within a first solid angle 1 of 0.05°, three light pulses 2 emitted successively or simultaneously are captured by means of the detector. Within a second solid angle 3, three light pulses 4 are also captured by means of the detector. Within a third solid angle 5, three light pulses 6 are also captured by means of the detector. Subsequently, a first histogram 7 is generated for the measurement data 15 of the first solid angle 1, a second histogram 8 is generated for the measurement data 16 of the second solid angle 3, and a third histogram 9 is generated for the measurement data 17 of the third solid angle 5. The measurement data 15, 16 and 17 are recorded by means of a macro-pixel, it being possible for at least 4, preferably 16, sub-pixels to be interconnected to form a macro-pixel. The histograms 7, 8 and 9 in this case are graphical representations of the measurement data 15, 16 and 17, with the amplitude of the individual pixels being represented by graphs. In the next step, using a threshold filter with an adaptable threshold value, received secondary light of the object is ascertained in a first echo diagram 10 for the first histogram 7, in a second echo diagram 11 for the second histogram 8 and in a third echo diagram 12 for the third histogram 9. In the next step of the method, using a coincidence filter, the first echo diagram 10 is compared with the second echo diagram 11, as indicated by the arrows, and a first aggregated echo diagram 13 is generated, with non-coinciding values for received secondary light of the object being filtered out and only coinciding values for received secondary light being retained. Accordingly, the second echo diagram 11 is compared with the third echo diagram 12, and a second aggregated echo diagram 14 is generated. Using the individual threshold filters and the coincidence filter ensures reliable recognition of the object by means of the lidar device, while eliminating interfering signals such as background noise and/or stray light. By applying the threshold filter to ascertain the echo diagrams 10, 11, 12 and then by applying the coincidence filter to generate the aggregated echo diagrams 13 and 14, it is possible to reliably ascertain the secondary light of the objects, while reliably filtering out background noise and/or stray light.

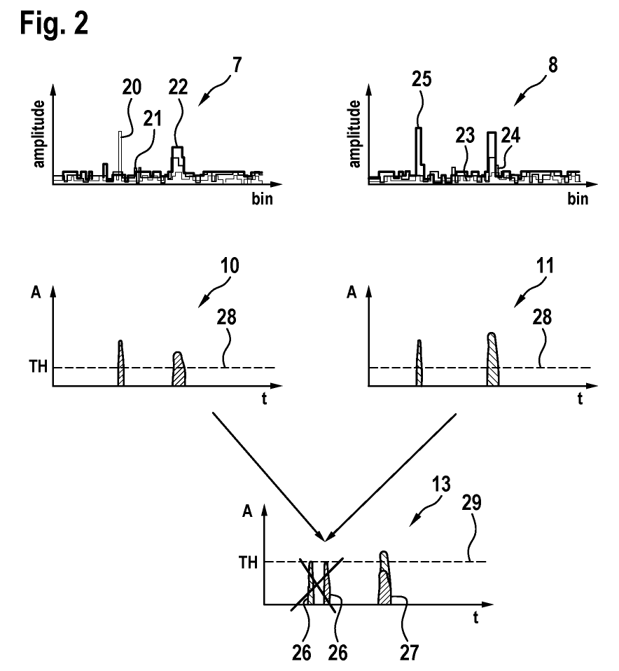

FIG. 2 shows a further schematic representation for illustrating the method from FIG. 1, with the first histogram 7 being a diagram that shows measured values of the lidar device. A first diagram 20 shows the values of a first light pulse, a second diagram 21 shows the measured values of a second light pulse and a third diagram 22 shows the measured values of a third light pulse within the first solid angle 1. The individual pixels of the detector of the lidar device are plotted on the x-axis, while the amplitude of the measured values for received light is plotted on the y-axis. The second histogram 8 of the second solid angle 3 is correspondingly shown as a fourth diagram 23 with the values of the first light pulse, a fifth diagram 24 with the values of the second light pulse and as a sixth diagram 25 with the values of the third light pulse within the second solid angle 3. In the next method step, the first echo diagram 10 is generated from the first histogram 7 using a threshold filter with an adaptable threshold value 28, and the second echo diagram 11 is generated for the second histogram 8. The time t for the temporal course is plotted on the x-axis of the echo diagram 10, 11 and the amplitude A of the measured values is plotted on the y-axis. In the next method step, the first echo diagram 10 is aggregated with the second echo diagram 11 using the coincidence filter, thus forming the first aggregated echo diagram 13, with non-coinciding measured values 26 of the secondary light being filtered out and coinciding measured values 27 of the secondary light being retained, so that the object is reliably detected. In a further method step, measured values 26 of the secondary light below an adaptable or fixed threshold value 29 can additionally be filtered out using a further second threshold filter.

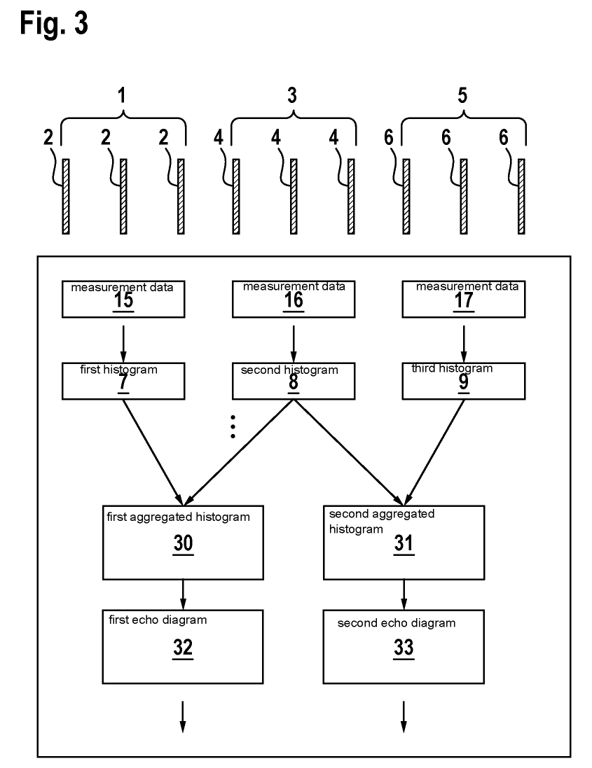

FIG. 3 is a schematic representation for explaining an alternative embodiment of the method, in which, in contrast to the method of FIG. 1 and FIG. 2, in one method step a first aggregated histogram 30 is generated from the first histogram 7 and the second histogram 8, and a second aggregated histogram 31 is generated from the second histogram 8 and the third histogram 9, as indicated by the arrows. The aggregation is carried out, for example, by overlaying the individual pixels or values of the histograms. In the next method step, a first echo diagram 32 is then generated from the first aggregated histogram 30 by means of the threshold filter, and a second echo diagram 33 is generated from the second aggregated histogram 31. In a further step (not shown), a coincidence filter, as shown in FIG. 1 and FIG. 2, can be applied to the two echo diagrams 32 and 33 in order to generate an aggregated echo diagram and thereby filter out erroneous secondary light. By applying the aggregation of the individual histograms 7, 8 and 9 to generate the aggregated histograms 30, 31 and by applying the threshold filter to generate the echo diagrams 32 and 33, the signal data are, as an alternative to the method from FIG. 1 and FIG. 2, aggregated directly, with the result that, although higher computing power is required, improved ascertainment of secondary light in the signals is made possible, while background noise and/or stray light are reliably filtered out.

What is claimed is:

1. A method for detecting objects in a field of view of a lidar device, wherein the lidar device includes a transmitting unit comprising a laser source, a receiving unit including at least one detector, and a processor unit, the method comprising the following steps:
emitting a plurality of light pulses into adjacent solid angles;
measuring received secondary light of an object from the adjacent solid angles using at least one detector of the receiving unit and converting the measured received secondary light into individual digital signals of the respective adjacent solid angles;
aggregating the individual digital signals from the adjacent solid angles without reducing an angular resolution, wherein during the aggregation, at least partially coinciding signal structures are recognized using a first filter, with respect to their amplitude, in the individual digital signals of different ones of the solid angles for the object;
aggregating the individal digital signals by a threshold filter, wherein the processor unit compares the individual digital signals and/or aggregated signals with a threshold value, so that secondary light of the object received in the individual digital signals is differentiated from interfering signals including background noise and/or stray light, and the interfering signals are filtered out.

2. The method according to claim 1, wherein the first filter is a coincidence filter and the individual digital signals are aggregated in the plurality of solid angles by adaptive filtering which is matched to properties of the individual digital signals, wherein individual threshold values of the threshold filter are adapted to an amplitude of the background noise and/or threshold values of the threshold filter are adapted to a distance of the object and/or threshold values of the threshold filter are adapted to an amplitude of a stray light, in the case the object was recorded in close proximity.

3. The method according to claim 1, wherein a deflection unit with rotating mirrors is used to scan the solid angles in a horizontal direction and/or a vertical direction.

4. The method according to claim 1, wherein the receiving unit includes detectors interconnected to form a macro-pixel, the macro-pixel including at least 4 sub-pixels interconnected to form a single macro-pixel, wherein signals from the sub-pixels are aggregated to form a common signal of the macro-pixel so that a signal-to-noise ratio is improved.

5. The method according to claim 1, wherein the light pulses are emitted either as individual light pulses per solid angle or as a plurality of light pulses per solid angle including at least 3 light pulses per solid angle.

6. The method according to claim 1, wherein the processor unit evaluates the aggregated signals for detecting objects in adjacent solid angles.

7. The method according to claim 1, wherein the individual digital signals are aggregated in a scan cycle which continuously performs measurements of the received secondary light in the adjacent solid angles.

8. The method according to claim 1, wherein the processor unit performs a real-time correction of signals in order to improve accuracy of object detection.

9. The method according to claim 1, wherein the processor unit includes a learning algorithm based on machine learning, wherein the learning algorithm is trained with training data from older measurements for detection of objects, and recognized objects are compared with actually present objects, wherein measurements with correctly recognized objects are given a higher weighting, so that an accuracy of the object detection is increased.

10. The method according to claim 1, wherein the receiving unit is configured to simultaneously process signals from a plurality of detectors.

11. The method according to claim 1, wherein the individual digital signals are aggregated by sequential processing of successively received light pulses, wherein a temporal correlation between the individual digital signals is used to recognize objects.

12. The method according to claim 1, wherein the individual digital signals are aggregated in adjacent solid angles in a range between 0.01° and 0.1° by, in a first step, converting the measured signals from a plurality of solid angles into histograms, wherein, in a second step, signal structures are recognized for each individual solid angle by applying a first threshold filter with an adaptable threshold value, wherein, in a third step, the recognized signal structures for the individual solid angles are compared using the coincidence filter and/or a second threshold filter with a second adaptable threshold value applied, so that secondary light of the object received in the individual signals is differentiated from interfering signals, including background noise and/or stray light, and the interfering signals are filtered out.

13. The method according to claim 1, wherein the individual digital signals are aggregated in adjacent solid angles in a range between 0.01° and 0.1° by, in a first step, converting the individual digital signals from a plurality of solid angles into histograms, wherein, in a second step, the histograms of at least two adjacent solid angles are aggregated and at least one aggregated histogram is generated, wherein, in a third step, signal structures are recognized in the aggregated histogram by applying a first threshold filter with an adaptable threshold value, wherein, in a fourth step, the recognized signal structures for individual solid angles are compared using the coincidence filter and/or a second threshold filter with a second adaptable threshold value is applied, so that secondary light of the object received in the individual digital signals is differentiated from interfering signals, including background noise and/or stray light, and the interfering signals are filtered out.

14. A system for detecting objects in a field of view of a lidar device, comprising:
a transmitting unit including at least one laser source;
a receiving unit including at least one detector;
a deflection unit; and
a processor unit;
wherein the system is configured such that a plurality of light pulses are emitted into respective adjacent solid angles,
wherein received secondary light from the adjacent solid angles is measured using at least one detector of the receiving unit and converted into individual digital signals of the respective adjacent solid angles,
wherein the individual digital signals signals from the respective adjacent solid angles are aggregated without reducing the angular resolution,
wherein the individual digital signals are aggregated by a threshold filter,
wherein the processor unit compares the individual digital signals and/or the aggregated signals with an adaptable threshold value in order to differentiate echo signals of an object from background noise and filter out the background noise.
